(19) United States
(12) Patent Application Publication
(10) Pub. No.: US 2006/0023621 A1
(43) Pub. Date: Feb. 2, 2006

(54) Information storage medium, recording/reproducing apparatus and recording/reproducing method

(75) Inventors: Sung-hee Hwang, Suwon-si (KR); Jung-wan Ko, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/186,829

(22) Filed: Jul. 22, 2005

(30) Foreign Application Priority Data
Jul. 28, 2004 (KR) 2004-59124

(51) Int. Cl. G11B 7/24

(52) U.S. Cl. 369/275.3; 369/275.1

(57) ABSTRACT

An information storage medium, a recording/reproducing apparatus therefor, and a recording/reproducing method thereof to manage last recorded addresses of data. The recording apparatus includes: a write unit which records data on an information storage medium including a lead-in area, a data area and a lead-out area, wherein the data area includes a user data area for recording user data and a spare area for recording replacement data for replacing data recorded in the user data area; and a controller which controls the write unit to record the replacement data in the spare area or a unrecorded area of the user data area, and record a logical last recorded address (LRA) of data in a logical volume space of the user data area in the lead-in area or the lead-out area. Accordingly, data can be reliably recorded and reproduced by effectively managing the LRA of the user data area.

### CROSS-REFERENCE TO RELATED APPLICATIONS

This application claims the benefit of Korean Patent Application No. 2004-59124, filed on Jul. 28, 2004 in the Korean Intellectual Property Office, the disclosure of which is incorporated herein in its entirety by reference.

### BACKGROUND OF THE INVENTION

1. Field of the Invention

An aspect of present invention relates to a disc, and more particularly, to an information storage medium for managing a last recorded address of a user data area, a recording/reproducing apparatus therefor and a recording/reproducing method thereof.

2. Description of the Related Art

For rewritable information storage media that includes a lead in area, a data area and a lead out area, a spare area is usually reserved in the data area. If a defect is detected while data is being recorded in a user data area (i.e., the area obtained by excluding the spare area from the data area), or when the data recorded in the user data area is being reproduced, replacement data is recorded in the spare area to replace the defective data.

For write-once information storage media, the above defect management method is used for a logical overwrite (LOW). The LOW is a method of using the write-once information storage media in a similar way to the rewritable information storage media. That is, to update data already recorded in the user data area, data is recorded in the spare area to replace the recorded data by treating the recorded data as if it was defect data. This makes data management simple since it can appear to a host as if the data in the user data area is overwritten at the same location by fixing a logical address of the data recorded in the user data area and assigning a physical address corresponding to the logical address to data recorded in the spare area, as long as the host refers to only the logical address.

However, a new method suggests recording data updated by LOW implementation according to defect management in an unrecorded area of a user data area on a disc without being limited to a spare area, and generating its replacement information (i.e., defect entry information), to maximize the use of disc capacity.

For a conventional LOW method by which replaced (i.e. updated) data is recorded only in a spare area, a logical volume space for a user data area of a disc (i.e., the actual capacity of the disc) corresponds to a physical volume space for a user data area on the disc one to one. That is, a recording area in the logical volume space is also a recording area in the physical volume space, and an unrecorded area in the logical volume space is also an unrecorded area in the physical volume space. A gap can exist according to a difference between the volume of a sector (2048 bytes), which is a basic unit for managing data in a host, and the volume of a block (32 Kbytes or 64 Kbytes), which is a basic unit for recording/reproducing in a drive system. That is, when the drive system receives a data write command of fewer sectors than one block from the host, the drive system completes one block by adding padding data to the sectors before recording the block. In this case, a gap can also exist.

However, by recording the updated data in the unrecorded area of the user data area for the LOW without limiting the data to the spare area, the logical volume space on the host side for the user data area of the disc no longer corresponds one to one to the physical volume space on the disc side for the user data area on the disc. In other words, it cannot be guaranteed that an unrecorded area in the logical volume space is also an unrecorded area in the physical volume space.

A detailed example will now be described with reference to FIGS. 1A and 1B. FIGS. 1A and 1B are reference diagrams illustrating a gap between a logical volume space and a physical volume space according to a related art method. In FIGS. 1A and 1B, a last recorded address (LRA) in the logical volume space is different from an LRA in the physical volume space.

A file system such as universal data format (UDF) of a DVD has an anchor point including location information in which information related to a volume space of the file system is recorded at a last sector number (LSN), an LSN-256, or a 256th address of the logical volume space. In this manner the LRA can be the beginning point for a host to read when the disc is loaded. However, according to recording data and a file system on a medium, the location of the LRA on the disc can vary. Accordingly, by the drive system recording the LRA on the medium providing the LRA recorded on the medium to the host when the disc is loaded in a drive system, the host can easily obtain the information related to the file system by transmitting a reproduction command based on the LRA received from the drive system.

Referring to FIG. 1A, a data area includes a spare area (SA), a user data area and another SA sequentially, and data A is recorded from the beginning address of the user data area. In this case, a logical volume space of the user data area and a physical volume space are equal.

However, as shown in FIG. 1B, if updated data A is recorded next to the data A in order to replace the data A recorded in the user data area, the physical LRA in the physical volume space of the user data area is the end of the updated data A, whereas the logical LRA in the logical volume space of the user data area is still the end of the location at which the data is first recorded. That is, since the data is only updated logically, only the updated data A exists in the logical volume space. However, physically, since the updated data A is recorded in the user data area separately from the first recorded data A due to the unrewritable characteristics of a write-once recording medium, both the first recorded data A and the updated data A exist in the physical volume space. Accordingly, the physical LRA in the physical volume space is different from the logical LRA in the logical volume space.

Therefore, conventionally, it was sufficient only that the drive system recorded the physical LRA on the medium, since the physical LRA and the logical LRA were equal. However, since replacement data is recorded in a unrecorded area of the user data area as well as the spare area, it is no longer sufficient to record only the physical LRA.

### SUMMARY OF THE INVENTION

An aspect of present invention provides an information storage medium that enables efficient management of address information at which data is last recorded in a user data area, a recording/reproducing apparatus therefor, and a recording/reproducing method thereof.

According to an aspect of the present invention, there is provided an information storage medium comprising a lead-in area, a data area and a lead-out area in series, wherein the data area includes a user data area for recording user data and a spare area for recording replacement data for replacing data recorded in the user data area, the replacement data is recorded in the spare area or a unrecorded area of the user data area, and a logical last recorded address (LRA) of the user data in a logical volume space of the user data area is recorded in the lead-in area or the lead-out area.

In accordance with an aspect of the present invention, the physical LRA of data in a physical volume space of the user data area may be further recorded in the medium. The LRA may be a logical address or a physical address corresponding to the logical address. The LRA may be recorded as a temporary disc definition structure (TDDS) in a temporary disc management area (TDMA) prepared in the lead-in area or the lead-out area. The medium may be a write-once information storage medium.

In accordance with an aspect of the present invention, if the replacement data is recorded, a replacement entry including address information of the original data before the replacement and address information of the replacement data after the replacement may be further recorded in the lead-in area or the lead-out area. The replacement entry may be recorded as temporary defect list (TDFL) information in the TDMA prepared in the lead-in area or the lead-out area.

According to another aspect of the present invention, there is provided a recording apparatus comprising: a write unit which records data on an information storage medium including a lead-in area, a data area and a lead-out area, wherein the data area includes a user data area for recording user data and a spare area for recording replacement data for replacing data recorded in the user data area; and a controller which controls the write unit to record the replacement data in the spare area or a unrecorded area of the user data area and record a logical last recorded address (LRA) of data in a logical volume space of the user data area in the lead-in area or the lead-out area.

According to another aspect of the present invention, there is provided a reproducing apparatus comprising: a read unit which reads data from an information storage medium including a lead-in area, a data area and a lead-out area, wherein the data area includes a user data area for recording user data and a spare area for recording replacement data for replacing data recorded in the user data area, and the replacement data is recorded in the spare area or a unrecorded area of the user data area; and a controller which controls the read unit to read a logical last recorded address (LRA) of data in a logical volume space of the user data area from the lead-in area or the lead-out area.

According to another aspect of the present invention, there is provided a recording method comprising: in an information storage medium including a lead-in area, a data area and a lead-out area, wherein the data area includes a user data area for recording user data and a spare area for recording replacement data for replacing data recorded in the user data area, recording replacement data in the spare area or a unrecorded area of the user data area; and recording a logical last recorded address (LRA) of data in a logical volume space of the user data area in the lead-in area or the lead-out area.

According to another aspect of the present invention, there is provided a reproducing method comprising: reading data from an information storage medium including a lead-in area, a data area and a lead-out area, wherein the data area includes a user data area for recording user data and a spare area for recording replacement data for replacing data recorded in the user data area, and the replacement data is recorded in the spare area or a unrecorded area of the user data area; and reading a logical last recorded address (LRA) of data in a logical volume space of the user data area from the lead-in area or the lead-out area.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B are reference diagrams illustrating a gap between a logical volume space and a physical volume space according to the related art;

FIG. 2 is a schematic block diagram of a recording/reproducing apparatus according to an embodiment of the present invention;

FIG. 3 is a detailed block diagram of the recording/reproducing apparatus shown in FIG. 2;

FIGS. 4A through 4D are structural diagrams of an information storage medium according to an embodiment of the present invention;

FIGS. 5A through 5D are reference diagrams illustrating a method of managing an LRA according to an embodiment of the present invention;

FIG. 6 is a reference diagram illustrating the LRA recorded examples shown in FIGS. 5A through 5D;

FIG. 7 is a reference diagram illustrating replacement entry recorded examples shown in FIGS. 5A through 5D;

FIG. 8 is a flowchart illustrating the process of recording an LRA and replacement entries according to an embodiment of the present invention; and

FIG. 9 is a flowchart illustrating the process of reproducing an LRA and replacement entries according to an embodiment of the present invention.

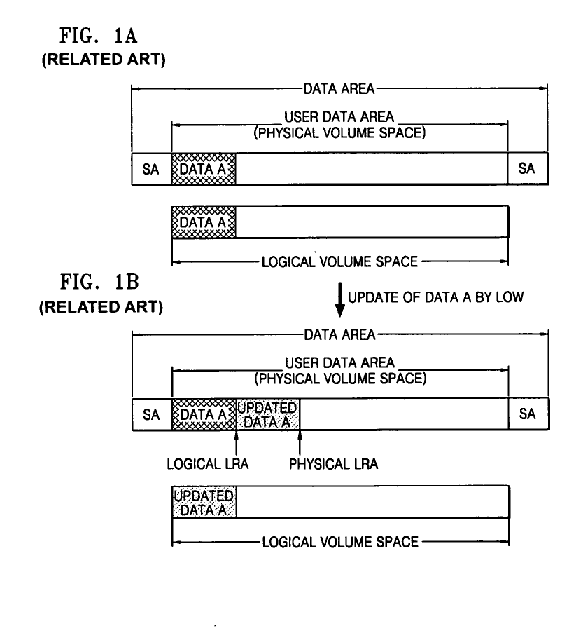

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

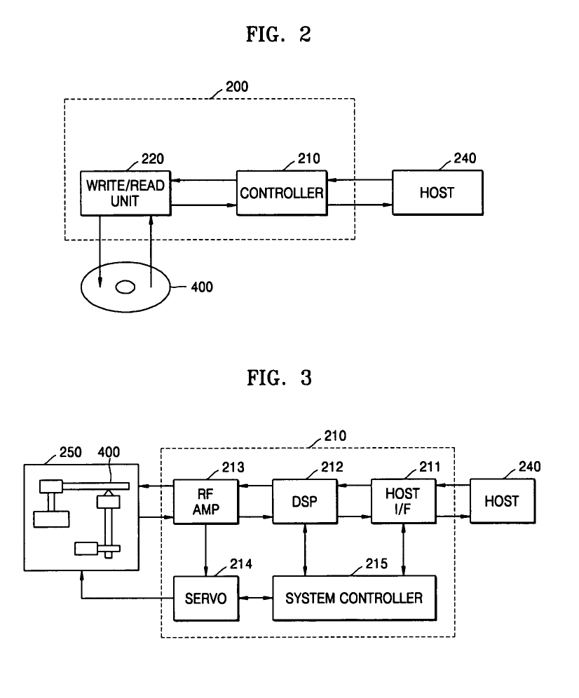

FIG. 2 is a schematic block diagram of a recording/reproducing apparatus 200 according to an embodiment of the present invention. Referring to FIG. 2, the recording/reproducing apparatus 200 includes a write/read unit 220 and a controller 210. Under the control of the controller 210, the write/read unit 220 records data on a disc 400, which is an information storage medium according to the present embodiment, and also reads and reproduces the recorded data. The controller 210 controls the write/read unit 220 to record data in blocks of a recording unit according to the present embodiment, or obtains valid data by processing read data using the write/read unit 220. The use of “/” throughout the specification is used to refer to and/or of the terms on each side of the “/.”

In a recording operation, the controller 210 controls the write/read unit 220 to record data by performing a logical overwrite (LOW) according to the command of a host 240 or the control of the recording/reproducing apparatus 200 itself. When using LOW to update original data recorded in a user data area of a write-once recording medium, the updated data (i.e. replacement data) is recorded in a spare area or an unrecorded area of the user data area, and address information of the original data and the replacement data is managed so that the logical address does not change from the point of view of the host 240. The controller 210 controls the write/read unit 220 to record data on the disc 400 using LOW, generate a replacement entry for managing the address information of the original data and replacement data, record the generated replacement entry in a lead-in area or lead-out area of the disc 400, and record a logical last recorded address (LRA) (or the logical LRA and a physical LRA) of the user data area in the lead-in area or lead-out area of the disc 400. Since location information relating to a volume space of a file system is recorded in the LRA of the user data area, the LRA is the beginning point for the host 240 to read the file system. Thus, the LRA is important in reproducing or recording operation.

FIG. 3 is a detailed block diagram of the recording/reproducing apparatus 200 shown in FIG. 2. Referring to FIG. 3, the recording/reproducing apparatus 200 includes a pickup 250 as the write/read unit 220. The disc 400 is coupled with the pickup 250 for read/write operations. The recording/reproducing apparatus 200 drive system also includes a host interface (I/F) 211, a digital signal processor (DSP) 212, a radio frequency amplifier (RF AMP) 213, a servo 214 and a system controller 215 as the controller 210.

In a recording operation, the host I/F 211 receives data to be updated and a write command with logical address information of the data to be updated, together from the host 240, and transmits them to the system controller 215.

The system controller 215 receives the write command from the host I/F 211 and performs initialization required for recording. In particular, according to the present embodiment, for implementing LOW, that is, to update data already recorded in the user data area, the system controller 215 controls the servo 214 to record updated data in an unrecorded area of a physical volume space of the user data area and generate a replacement entry so that the physical address of the updated data corresponds to the logical address of the updated data (the logical address is not changed even if the data is updated) according to the recording, and record the generated replacement entry in the lead-in area or lead-out area of the disc 400. The system controller 215 also controls the pickup 250 to record the logical LRA of the data of the logical volume space of the user data area in the lead-in area or lead-out area of the disc 400, or record both the logical LRA and the physical LRA in the lead-in area or lead-out area of the disc 400.

The DSP 212 adds additional data such as parity bits for error correction to the data to be written, received from the host I/F 211, generates an ECC block, which is an error correction block, by performing ECC encoding on the data, and modulates the generated ECC block. The RF AMP 213 converts the data output from the DSP 212 to an RF signal. The pickup 250 writes the RF signal output from the RF AMP 213 onto the disc 400. The servo 214 receives commands required for servo control from the system controller 215 and servo-controls the pickup 250.

In a reproducing operation, the host I/F 211 receives a reproduction command from the host 240. The system controller 215 performs initialization required for the reproduction. In particular, according to the present embodiment, the system controller 215 reads the logical LRA recorded on the disc 400, converts the logical LRA to a logical sector number (LSN), and transmits the LSN to the host 240. If a command to reproduce data of the LRA is received from the host 240, the system controller 215 calculates a physical sector number (PSN) corresponding to the LSN of the LRA, seeks a replacement entry recorded in the lead-in area or lead-out area of the disc 400, and seeks the location at which the PSN is replaced based on the replacement entry. The system controller 215 controls the pickup 250 to seek the area of the disc 400 corresponding to the replacement entry, read data from that area, and transmit the data to the host 240.

The pickup 250 radiates a laser beam onto the disc 400, and receives the reflected laser beam to obtain an optical output signal. The RF AMP 213 converts the optical signal output from the pickup 250 to an RF signal, provides modulated data obtained from the RF signal to the DSP 212, and provides a servo signal for servo control, obtained from the RF signal, to the servo 214. The DSP 212 demodulates the modulated data and outputs data obtained through ECC error correction.

The servo 214 performs servo control of the pickup 250 based on the servo signal received from the RF AMP 213 and the command required for the servo control received from the system controller 215. The host I/F 211 transmits the data received from the DSP 212 to the host 240.

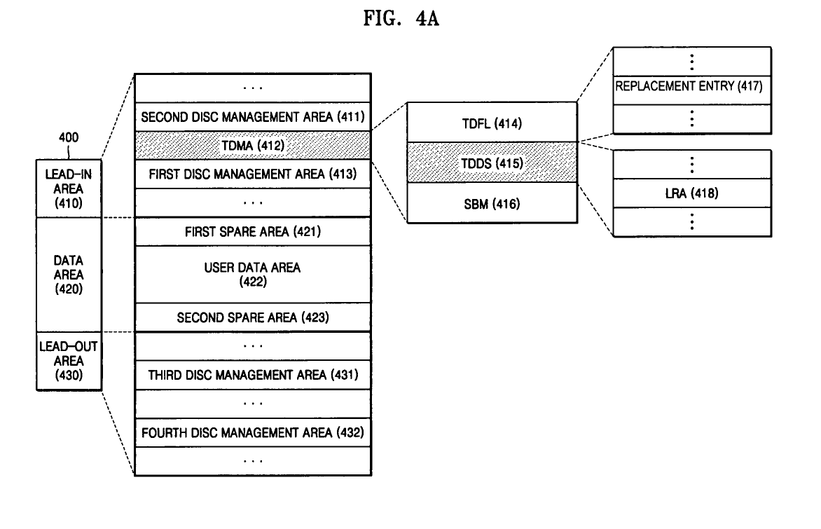

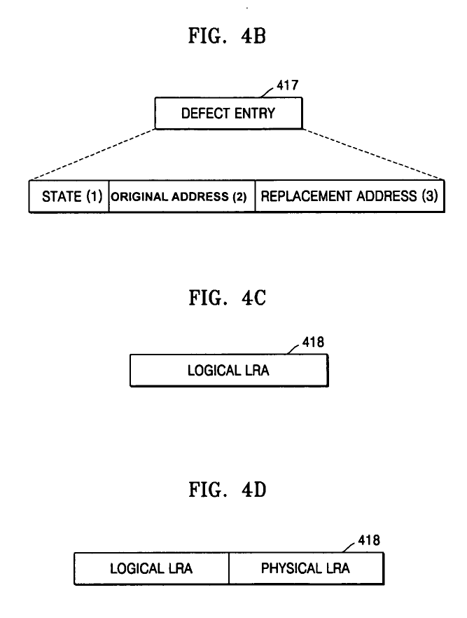

FIG. 4A shows the structure of an information storage medium according to an embodiment of the present invention. Referring to FIG. 4A, a data structure of data written on the write-once information storage medium 400 includes a lead-in area 410, a data area 420 and a lead-out area 430.

The lead-in area 410 includes a second disc management area 411, a temporary disc management area (TDMA) 412, and a first disc management area 413. The TDMA 412 is an area in which to write information on temporary defect management and temporary disc management for managing the write-once information storage medium.

The TDMA 412 includes a temporary defect list (TDFL) 414, a temporary disc definition structure (TDDS) 415 and a space bit map (SBM) 416. The TDFL 414 comprises data that indicates information on temporary defects and includes location information of defect data and location information of replacement data for replacing the defect data. In particular, according to the present embodiment, the TDFL includes a replacement entry 417.

Referring to FIG. 4B, the replacement entry 417 includes a state 1, an original address 2 and a replacement address 3. The state 1 indicates whether data of a user data area 422 is the beginning or the end of a recorded portion. The original address 2 indicates the address at which original data is recorded before data of the user data area 422 is replaced (i.e., updated), and the replacement address 3 indicates the address at which replacement data, which replaces (i.e., updates) the data of the user data area 422, is recorded.

The TDDS 415 includes location pointers of the TDFL 414, the SBM 416, and further includes location and size information of spare areas 421 and 423 assigned in an initializing operation, write protection information, location and size information of a temporary defect management area assigned in the data area 420, information on the user data area 422, and information on a replaceable location in each spare area 421 and 423. In particular, according to an aspect of the present embodiment, in the TDDS 415, a logical LRA 418 of the user data area 422 is recorded with reference to FIG. 4C, or a logical LRA and physical LRA 418 of the user data area 422 are recorded together with reference to FIG. 4D.

The SBM 416 is a map indicating whether the user data area 422 is written by representing whether each cluster of the user data area 422 is written using a bit value. The SBM 416 is used when the user data area 422 is used in a random recording mode, and recording management information indicating a data recording state as entry information is used when the user data area 422 is used in a sequential recording mode.

A first disc management area 413, a second disc management area 411, a third disc management area 431 and a fourth disc management area 432 are areas in which to record final disc management information when the write-once information storage medium is finalized.

The data area 420 sequentially includes a first spare area 421, the user data area 422 and a second spare area 423. The first and second spare areas 421 and 423 are areas in which to record replacement data for replacing data recorded in the user data area 422. The user data area 422 is an area in which to record user data. In particular, according to the present embodiment, replacement data for replacing user data is recorded in the spare areas 421 and 423 and the user data area 422.

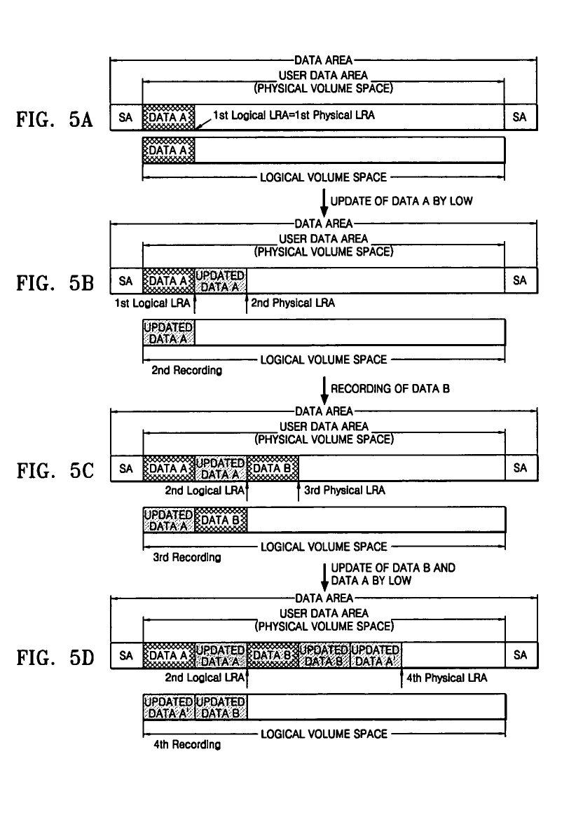

FIGS. 5A through 5D are reference diagrams illustrating a method of managing a LRA according to an embodiment of the present invention. FIG. 5A shows a disc state after a first recording, FIG. 5B shows a disc state after a second recording, FIG. 5C shows a disc state after a third recording, and FIG. 5D shows a disc state after a fourth recording.

It is assumed, by way of example, that an LSN of a logical volume space is divided into a range such as LSN 0 to LSN 31999, and a PSN of a physical volume space corresponding to the LSN is divided into a range such as PSN 10000 to PSN 41999. Also, it is assumed that each unit of data is equally composed of 320 sectors. Then, an LSN i corresponds to a PSN 10000+i.

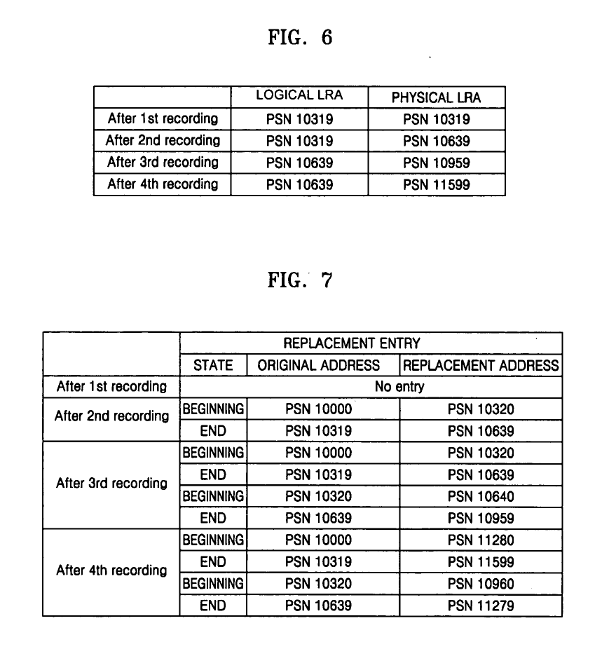

Referring to FIG. 5A, after the first recording, only data A is recorded at the beginning address of the user data area. Since no replacement has occurred, the logical LRA and the physical LRA of the user data area are equal. That is, after the first recording, the logical LRA and the physical LRA are the PSN 10319, and since no replacement has occurred, there is no replacement entry. Referring to FIG. 6, for LRA information recorded in a TDDS after the first recording, the PSN 10319 is recorded as the logical LRA and the physical LRA.

Referring to FIG. 5B, after the second recording, updated data A is recorded next to the data A. The logical LRA is not changed since only data related to the data A still exists in the logical volume space, whereas the physical LRA is changed since the updated data A is recorded next to the data A in the physical volume space. That is, after the second recording, the logical LRA is still the PSN 10319, and the physical LRA is the PSN 10639.

Referring to FIG. 6 again, for the LRA information recorded in the TDDS after the second recording, the PSN 10319 and the PSN 10639 are respectively recorded as the logical LRA and the physical LRA.

Referring to FIG. 7, after the second recording, two replacement entries are generated to represent that the PSN 10000 to the PSN 10319 are replaced with the PSN 10320 to the PSN 10639. One is a replacement entry related to beginning addresses of the original data before the replacement and the replacement data, and the other is a replacement entry related to end addresses of the original data before the replacement and the replacement data. The replacement entry related to the beginning addresses has a state field represented by “beginning”, the beginning address of the original data “PSN 10000” is recorded in an original address field, and the beginning address of the replacement data “PSN 10320” is recorded in a replacement address field. The replacement entry related to the end addresses has the state field represented by “end”, the end address of the original data “PSN 10319” is recorded in the original address field, and the end address of the replacement data “PSN 10639” is recorded in the replacement address field.

Referring to FIG. 5C, after the third recording, data B is recorded next to the updated data A in the physical volume space. After the third recording, the updated data A and the data B are recorded in the logical volume space, and the data A, the updated data A and the data B are recorded in the physical volume space. Compared to the situation after the second recording, the logical LRA is changed, and the physical LRA is also changed since the data B has been recorded next to the updated data A.

Referring back to FIG. 6, for the LRA information recorded in the TDDS after the third recording, the PSN 10639 and the PSN 10959 are respectively recorded as the logical LRA and the physical LRA.

After the third recording, replacement entries are added indicating that the PSN 10320 to the PSN 10639 are replaced with the PSN 10640 to the PSN 10959 in order to represent that the data B is additionally recorded on the disc 400. If a physical volume space corresponding to a logical volume space in which the data B is recorded is an unrecorded area, these replacement entries are made unnecessary by recording the data B in the physical volume space corresponding to the logical volume space. However, as shown in FIG. 5C, if a drive system has already used the physical volume space corresponding to the logical volume space in which the data B is recorded, due to the update of the data A (i.e., updated data A) by LOW, then the data B cannot be recorded in the already used physical volume space, the drive system 200 must record the data B in a new unrecorded physical volume space and generate and record replacement entries for the replacement to compensate for the difference between the logical PSN and the physical PSN.

Referring back to FIG. 7, after the third recording, two replacement entries are generated to represent that the PSN 10320 to the PSN 10639 are replaced with the PSN 10640 to the PSN 10959. One is a replacement entry related to beginning addresses, thereby representing “beginning” in the state field and recording the beginning address of the original data “PSN 10320” in the original address field and the beginning address of the replacement data “PSN 10640” in the replacement address field, and the other is a replacement entry related to end addresses, thereby representing “end” in the state field and recording the end address of the original data “PSN 10639” in the original address field and the end address of the replacement data “PSN 10959” in the replacement address field.

Referring to FIG. 5D, after the fourth recording, updated data B and updated data A′ are recorded next to the data B in the physical volume space. After the fourth recording, the updated data A′ and the updated data B are recorded in the logical volume space, and the data A, the updated data A, the data B, the updated data B and the updated data A′ are recorded in the physical volume space. That is, after the fourth recording, the logical LRA is still the PSN 10639, and the physical LRA is the PSN 11599.

Referring back to FIG. 6, for the LRA information recorded in the TDDS after the fourth recording, the PSN 10639 and the PSN 11599 are respectively recorded as the logical LRA and the physical LRA.

Referring back to FIG. 7, after the fourth recording, for the replacement entries generated due to the update of the data B and the second update of data A (i.e., updated data A′), the replacement addresses of the replacement entry generated after the third recording (i.e. by the recording of the data B) are changed to the PSN 10960 to the PSN 11279, and the replacement addresses of the replacement entry generated after the second recording (i.e. by the second update of the data A) are changed to the PSN 11280 to the PSN 11599.

That is, in FIG. 7, the first two of the four replacement entries generated after the fourth recording are replacement entries related to the data A, and the remaining two replacement entries are replacement entries related to the data B. Referring to FIG. 7, the first two replacement entries indicate that the original addresses of the data A are the PSN 10000 to the PSN 10319 and the replacement addresses of the replacement data for replacing the data A (i.e., updated data A′) are the PSN 11280 to the PSN 11599. The last two replacement entries indicate that the original addresses of the data B are the PSN 10320 to the PSN 10639 and the replacement addresses of the replacement data for replacing the data B (i.e., updated data B) are the PSN 10960 to the PSN 11279. As described above, continuous replacements can be effectively represented using two replacement entries indicating a beginning and an end.

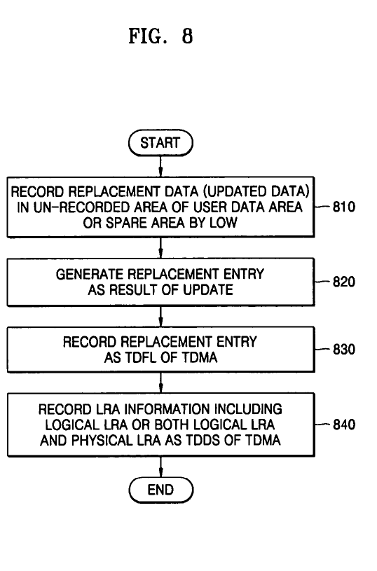

FIG. 8 is a flowchart illustrating the process of recording an LRA and replacement entries according to an embodiment of the present invention. The recording of the LRA and the replacement entries is shown in a recording operation. Referring to FIG. 8, according to the LOW, to update data already recorded in a user data area, replacement data (i.e., updated data) for replacing the already recorded data is recorded in an unrecorded area of the user data area or a spare area, in operation 810.

A replacement entry is generated as a result of the update operation, in operation 820. That is, as described with reference to FIGS. 5 and 7, when the data already recorded in the user data area is updated, or even if new data is recorded, when other data has been recorded in a physical volume space corresponding to a logical volume space for the new data to be recorded, the replacement entry is generated.

The generated replacement entry is recorded as a TDFL in a TDMA of a disc in operation 830. LRA information, including either a logical LRA or both a logical LRA and a physical LRA, is recorded as a TDDS in the TDMA in operation 840.

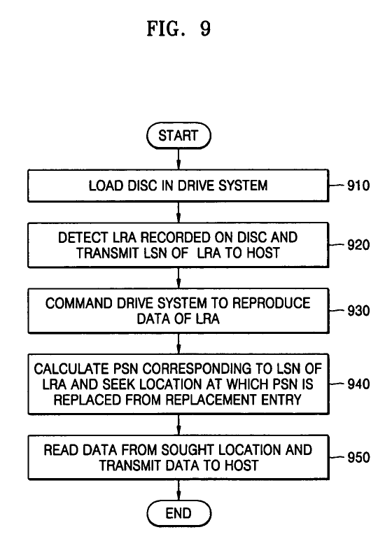

FIG. 9 is a flowchart illustrating the process of reproducing an LRA and replacement entries according to an embodiment of the present invention. Referring to FIG. 9, when a disc on which data is recorded and updated according to the method shown in FIG. 8 is loaded into a drive system, for example the recording/reproducing apparatus 200 of FIG. 2, in operation 910, the drive system 200 first detects the LRA recorded on the disc 400 in order to provide the LRA to a host 240, and transmits the LRA as a LSN value to the host 240 in operation 920. Referring back to FIG. 8, the LRA is recorded in the TDFL area of the disc 400, in which only a logical LRA or both a logical LRA and a physical LRA can be recorded.

The host 240, which has received the LRA from the drive system 200, commands the drive system 200 to reproduce data from the LRA in operation 930.

The drive system 200 then calculates a PSN corresponding to the LSN of the LRA in response to the command received from the host 240, and seeks the location at which the PSN is replaced from a replacement entry in operation 940. The replacement entry is recorded in the TDFL area of the disc 400, as described with reference to FIG. 8.

The drive system 200 reads the data at the location on the disc 400 using the sought location and transmits the read data to the host 240 in operation 950.

The operation of FIG. 9 will now be described with reference to the examples shown in FIGS. 5 through 7. When the host 240 requests the LRA, the drive system 200 transmits the LSN 639 corresponding to the PSN 10639, which is the logical LRA, to the host 240. When the host 240 commands the drive system 200 to reproduce data from the disc 400 corresponding to the LSN 639, the drive system seeks the PSN 10639 corresponding to the LSN 639 and examines the replacement entry. The drive system 200 detects that the PSN 10639 is replaced with the PSN 11279 from the replacement entry, reproduces the data from the disc 400 corresponding to the PSN 11279, and transmits the reproduced data to the host 240.

The embodiments of the present invention can be written as computer programs and can be implemented in general-use digital computers that execute the programs using a computer readable recording medium. Examples of the computer readable recording medium include magnetic storage media (e.g., ROM, floppy discs, hard discs, etc.), optical recording media (e.g., CD-ROMs, DVDs, etc.), and storage media such as carrier waves (e.g., transmission through the internet). The computer readable recording medium can also be distributed over network coupled computer systems so that the computer readable code is stored and executed in a distributed fashion. The functional programs, code and code segments for embodying the present invention may be easily deducted by programmers in the art which the present invention belongs to.

As described above, according to the present invention, in a LOW system implemented to record replacement data in not only a spare area but also a unrecorded area of a user data area, data can be reliably recorded and reproduced by effectively managing the LRA of the user data area, in which is recorded location information related to volume spaces of a file system.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An information storage medium for use with a recording/reproducing apparatus, comprising:
a lead-in area, a data area and a lead-out area,
wherein the data area includes a user data area to record user data and a spare area to record replacement data to replace data recorded in the user data area, the replacement data to replace the data recorded in the user data area is recorded in the spare area or in a unrecorded area of the user data area, and a logical last recorded address (LRA) of the user data in a logical volume space of the user data area is recorded in the lead-in area or the lead-out area.

2. The medium of claim 1, wherein a physical LRA of the user data in a physical volume space of the user data area is further recorded in the medium.

3. The medium of claim 2, wherein the logical LRA is a logical address or a physical address corresponding to the logical address.

4. The medium of claim 2, wherein the logical LRA is recorded as a temporary disc definition structure (TDDS) in a temporary disc management area (TDMA) arranged in the lead-in area or the lead-out area.

5. The medium of claim 2, wherein the medium is a write-once information storage medium.

6. The medium of claim 2, wherein if the replacement data is recorded, a replacement entry including address information of the user data before recording the replacement data and address information of the replacement data is further recorded in the lead-in area or the lead-out area.

7. The medium of claim 6, wherein the replacement entry is recorded as temporary defect list (TDFL) information in the TDMA arranged in the lead-in area or the lead-out area.

8. The medium of claim 1, wherein the logical LRA is a logical address or a physical address corresponding to the logical address.

9. The medium of claim 1, wherein the logical LRA is recorded as a temporary disc definition structure (TDDS) in a temporary disc management area (TDMA) arranged in the lead-in area or the lead-out area.

10. The medium of claim 1, wherein the medium is a write-once information storage medium.

11. The medium of claim 1, wherein if the replacement data is recorded, a replacement entry including address information of the user data before recording the replacement data and address information of the replacement data is further recorded in the lead-in area or the lead-out area.

12. The medium of claim 11, wherein the replacement entry is recorded as temporary defect list (TDFL) information in the TDMA arranged in the lead-in area or the lead-out area.

13. A recording apparatus, comprising:
a write unit which records data on an information storage medium including a lead-in area, a data area and a lead-out area, wherein the data area includes a user data area to record user data and a spare area to record replacement data for replacing data recorded in the user data area; and
a controller which controls the write unit to record the replacement data in the spare area or an unrecorded area of the user data area, and record a logical last recorded address (LRA) of the replacement data in a logical volume space of the user data area in the lead-in area or the lead-out area.

14. The apparatus of claim 13, wherein the controller controls the write unit to further record a physical LRA of data of a physical volume space of the user data area on the medium.

15. The apparatus of claim 14, wherein the logical LRA is a logical address or a physical address corresponding to the logical address.

16. The apparatus of claim 14, wherein the controller controls the write unit to record the logical LRA as a temporary disc definition structure (TDDS) in a temporary disc management area (TDMA) prepared in the lead-in area or the lead-out area.

17. The apparatus of claim 14, wherein if the replacement data is recorded, the controller controls the write unit to further record a replacement entry, which includes address information of the user data before recording the replacement data and address information of the replacement data, in the lead-in area or the lead-out area.

18. The apparatus of claim 17, wherein the controller controls the write unit to record the replacement entry as temporary defect list (TDFL) information in the TDMA prepared in the lead-in area or the lead-out area.

19. The apparatus of claim 13, wherein the controller controls the write unit to further record a physical LRA of data of a physical volume space of the user data area on the medium.

20. The apparatus of claim 13, wherein the logical LRA is a logical address or a physical address corresponding to the logical address.

21. The apparatus of claim 13, wherein the controller controls the write unit to record the logical LRA as a temporary disc definition structure (TDDS) in a temporary disc management area (TDMA) prepared in the lead-in area or the lead-out area.

22. The apparatus of claim 13, wherein if the replacement data is recorded, the controller controls the write unit to further record a replacement entry, which includes address information of the user data before recording the replacement data and address information of the replacement data, in the lead-in area or the lead-out area.

23. The apparatus of claim 22, wherein the controller controls the write unit to record the replacement entry as temporary defect list (TDFL) information in the TDMA prepared in the lead-in area or the lead-out area.

24. A reproducing apparatus, comprising:
a read unit which reads data from an information storage medium including a lead-in area, a data area and a lead-out area, wherein the data area includes a user data area to record user data and a spare area to record replacement data to replace data recorded in the user data area, and the replacement data is recorded in the spare area or an unrecorded area of the user data area; and
a controller which controls the read unit to read a logical last recorded address (LRA) of data in a logical volume space of the user data area from the lead-in area or the lead-out area.

25. A recording method, comprising:
recording replacement data, which updates user data, in a spare area or an unrecorded area of a user data area on an information storage medium, wherein the medium includes a lead-in area, a data area, and a lead-out area, wherein the data area includes the user data area to record user data and/or the replacement data and the spare area to record the replacement data to replace data recorded in the user data area, and
recording a logical last recorded address (LRA) of the replacement data in a logical volume space of the user data area in the lead-in area or the lead-out area.

26. The method of claim 25, further comprising:
recording a physical LRA of data of a physical volume space of the user data area in the lead-in area or the lead-out area.

27. The method of claim 26, wherein the logical LRA is a logical address or a physical address corresponding to the logical address.

28. The method of claim 26, wherein the recording of the logical LRA comprises:
recording the logical LRA as a temporary disc definition structure (TDDS) in a temporary disc management area (TDMA) prepared in the lead-in area or the lead-out area.

29. The method of claim 26, further comprising:
recording a replacement entry corresponding to the replacement data, the replacement entry including address information of the user data before the recording the replacement data and address information of the replacement data, in the lead-in area or the lead-out area.

30. The method of claim 29, wherein the recording the replacement entry comprises:
recording the replacement entry as temporary defect list (TDFL) information in the TDMA arranged in the lead-in area or the lead-out area.

31. The method of claim 25, wherein the logical LRA is a logical address or a physical address corresponding to the logical address.

32. The method of claim 25, wherein the recording of the logical LRA comprises:
recording the logical LRA as a temporary disc definition structure (TDDS) in a temporary disc management area (TDMA) prepared in the lead-in area or the lead-out area.

33. The method of claim 25, further comprising:
recording a replacement entry corresponding to the replacement data, the replacement entry including address information of the user data before the recording the replacement data and address information of the replacement data, in the lead-in area or the lead-out area.

34. The method of claim 33, wherein the recording the replacement entry comprises:
recording the replacement entry as temporary defect list (TDFL) information in the TDMA arranged in the lead-in area or the lead-out area.

35. A reproducing method, comprising:
reading data from an information storage medium including a lead-in area, a data area and a lead-out area, wherein the data area includes a user data area to record user data and a spare area to record replacement data to replace data recorded in the user data area, and the replacement data is recorded in the spare area or an unrecorded area of the user data area; and
reading a logical last recorded address (LRA) of the data in a logical volume space of the user data area from the lead-in area or the lead-out area.

36. A write-once information storage medium for use with a recording and/or reproducing apparatus, comprising:
a first recording area which stores user data recorded by the apparatus; and
a second recording area which stores replacement data recorded by the apparatus, wherein the replacement data is used by the apparatus to update the user data in the first recording area according to a disc defect management method in which the apparatus records a logical last recorded address (LRA) of the replacement data or the user data in a logical volume space of the first area.

37. The information storage medium of claim 36, wherein the first recording area comprises a user data area and the second recording area comprises a spare area.

38. The information storage medium of claim 37, wherein the apparatus records the logical LRA in one of a lead-in area or a lead-out area, which are in a third recording area of the information storage medium separate from the first and second recording areas.

39. The information storage medium of claim 38, wherein the logical LRA is recorded by the apparatus as a temporary disc definition structure (TDDS) in a temporary disc management area (TDMA) arranged in the lead-in area or the lead-out area.

40. The information storage medium of claim 38, wherein a replacement entry including address information of the user data which has not been updated and address information of the replacement data is recorded by the apparatus in the lead-in area or the lead-out area.

41. The information storage medium of claim 40, wherein the replacement entry is recorded as temporary defect list (TDFL) information in a TDMA arranged in the lead-in area or the lead-out area.

42. The information storage medium of claim 40, wherein the apparatus calculates a physical sector number corresponding to the logical last recorded address to determine a location of the replacement entry.

43. The information storage medium of claim 36, wherein the logical LRA is a logical address or a physical address corresponding to the logical address.

44. A recording and/or reproducing apparatus, comprising:
an optical pickup which records data on and/or reads the data from a surface of a write-once information storage medium; and
a controller which controls the optical pickup to record and/or reproduce the data on the surface of the information storage medium and stores replacement data on the surface of the information storage medium,
wherein the information storage medium comprises a first recording area which stores the data recorded by the controller, and
a second recording area which stores the replacement data recorded by the apparatus, wherein the replacement data is recorded each time the apparatus records new data in the first recording area according to a disc defect management method in which the apparatus records a logical last recorded address (LRA) of the replacement data or the user data in a logical volume space of the first area.

45. The apparatus of claim 44, wherein the first recording area comprises a user data area and the second recording area comprises a spare area.

46. The apparatus of claim 44, wherein the logical LRA is recorded by the apparatus as a temporary disc definition structure (TDDS) in a temporary disc management area (TDMA) arranged in a lead-in area or the lead-out area of the disc on either side of the first and second recording areas.

47. The apparatus of claim 44, wherein the controller reads the logical LRA from the information storage medium during reproduction of the data and coverts the logical LRA to a logical sector number and calculates a physical sector number corresponding to the logical sector number for a location of the replacement data.
